(19) United States
(12) Patent Application Publication
(10) Pub. No.: US 2009/0091874 A1
(43) Pub. Date: Apr. 9, 2009

(54) Variable capacitance capacitor, method for producing the capacitor, and use of same

(75) Inventors: Mahmoud Al-Ahmad, Toulouse (FR); Richard Matz, Bruckmuhl (DE); Ruth Manner, Oberpframmem (DE); Steffen Walter, Oberpframmem (DE)

Correspondence Address: YOUNG & THOMPSON, 209 Madison Street, Suite 500, ALEXANDRIA, VA, 22314, US

(73) Assignee: SIEMENS AKTIENGESELLSCHAFT, Munchen (DE)

(21) Appl. No.: 11/920,081

(22) PCT Filed: May 30, 2006
(86) PCT No.: PCT/EP2006/062722

§ 371 Date: Nov. 8, 2007

(30) Foreign Application Priority Data
Jun. 7, 2005 (DE) 10 2005 026 203.1

(51) Int. Cl. H01G 7/06; B05D 5/12

(52) U.S. Cl. 361/281; 427/79

(57) ABSTRACT

A capacitor (10) with a variable capacitance, includes at least one electrode (11) and at least one counter-electrode (12) situated opposite the electrode at a variable distance (13) therefrom. The capacitor is characterized in that a dielectric shaped part (15) with a dielectric molding compound for evening out a surface roughness (113) of the electrode surface is arranged inside the space between the electrode and the counter-electrode on one of the electrode surfaces (111) of at least one of the electrodes. The method for producing the capacitor includes the following steps: a) providing the electrode of the capacitor; b) applying a dielectric molding compound to the surface of the electrode so that the electrode surface is shaped by the molding compound, and; c) transforming the dielectric molding compound into the shaped part thereby evening out the surface roughness of the electrode surface.

The invention relates to a variable capacitance capacitor with at least one electrode and at least one counter-electrode disposed at a variable distance from said electrode. A method for producing the capacitor and use of same are also specified.

A high-quality, variable capacitance capacitor (tunable capacitor) is required, for example, for a voltage controlled oscillator (VCO). Such a circuit is used as a reference frequency generator and for mixing channel frequencies and carrier frequencies in communication systems. To ensure maximum frequency stability, high-Q low-loss capacitors are required which, however, must be also be tunable over a wide range, thereby generally necessitating an unsatisfactory compromise. In addition to this application, tunable capacitors are also used for tunable filters in RF and microwave technology. An example of a frequency filter of this kind is a band pass filter. The pass band filter passes an RF signal within a particular band of frequencies (the pass band). This means that an attenuation factor for an RF signal within this frequency band is low.

DE 199 03 571 A1 discloses a capacitor of the type mentioned in the introduction. The capacitor has a fixed electrode non-detachably mounted to a silicon substrate. Disposed opposite said fixed electrode is a movable counter-electrode. Said counter-electrode is embodied as a cantilever. By electrically energizing the electrode and counter-electrode of the capacitor, an electrical field is generated which causes the movable counter-electrode to be moved toward the fixed electrode, thereby reducing the distance between the electrode and the counter-electrode and thus increasing the capacitance of the capacitor.

The known capacitor distinguishes itself from other tunable capacitors such as varactors (variable capacitance diodes) in being tunable over a wide capacitance range while at the same time being of high quality. To achieve this, a cantilever made of a material having no internal stress must be used. Such a cantilever, like the substrate, typically consists of monocrystalline silicon. To produce the capacitor, technologies are employed which are known in connection with so-called micro-electromechanical systems (MEMS).

With the known capacitor, cantilever spring stiffness must be taken into account. This means that to set a desired distance between the electrodes, a restoring force based on spring stiffness must be overcome. For this purpose a relatively high voltage must be applied to the electrodes. Alternatively, the cantilever spring stiffness can be reduced by additional design features, such as folding the cantilever. In this way lower voltages are sufficient to set a specific distance between the electrodes.

Because of its electrostatic operating principle, the known capacitor is unstable. This means that the capacitor can only be switched between two capacitance states.

As soon as the two electrodes of the capacitor are mutually attracted due to electrostatic forces, the capacitance increases and, even at constant voltage, additional charge flows to the electrodes which increases the attractive force. The end position of the movable electrode is constituted by a mechanical stop. Said mechanical stop can be of graduated design to that a plurality of discrete states can be set. However, continuous tuning of the capacitance is basically not possible.

The capacitor can be provided with large tuning range by making an air gap resulting from the distance between the electrode and the counter-electrode as small as possible. However, because of the surface roughness of the electrodes involved, the air gap cannot be of any desired smallness—unless the electrode surfaces are mechanically and/or chemically polished which is very costly.

The object of the present invention is therefore to specify a capacitor that is precisely tunable over a wide range and is also easy to manufacture.

This object is achieved by a variable capacitance capacitor having at least one electrode and at least one counter-electrode disposed at a variable distance from said electrode. The capacitor is characterized in that, within the distance between the electrode and the counter-electrode, there is disposed on one of the surfaces of at least one of the electrodes a dielectric molding containing a dielectric molding material for smoothing out any electrode surface roughness. The molding forms a dielectric layer of fixed layer thickness. The variable distance between the electrodes results from an air gap of variable width.

The object is also achieved by a method for producing the capacitor, comprising the following steps:

a) Providing the capacitor electrode, b) applying a dielectric molding compound to the electrode surface so that an impression of the electrode surface is taken by the molding compound and c) transforming the dielectric molding compound into the dielectric molding with the dielectric molding material, causing the surface roughness of the dielectric surface to be smoothed out. The method can be carried out correspondingly for the counter-electrode.

The molding is a dielectric layer which is applied directly to the electrode surface and/or the counter-electrode surface and which is produced from the dielectric molding compound. The term “molding compound” is generally to be understood as meaning a product and in particular a plastic product which can be permanently formed into a molding (molding material) by non-cutting shaping. The term “non-cutting shaping” is to be understood as meaning, for example, injection molding, extruding or pressing. The molding compound is plastically deformable.

The underlying idea of the invention consists of smoothing out electrode surface roughness (surface texture) with the aid of the molding compound. Due to its deformability, the molding compound conforms to the texture of the electrode surface. The surface roughness of the electrode surface is characterized, for example, by a particular peak to valley height. The peak to valley height is the distance along a normal of the electrode surface between a highest and a lowest point of the electrode surface. By smoothing out the surface roughness, a very small air gap between the surfaces of the electrode and counter-electrode is possible. The small air gap means that the capacitor is highly tunable. The invention also enables the small air gap to be easily achieved. Mechanical and/or chemical polishing of the electrode surface, which would be very expensive, is not necessary.

According to a particular embodiment, the dielectric molding material of the molding has an effective relative dielectric constant of at least 20 and in particular of at least 40. The dielectric molding material has a maximally high relative dielectric constant. The distance d between the electrode and the counter-electrode corresponds to the sum of the layer thickness d₁ of the dielectric layer and the air gap width d₂. The width d₂ of the air gap can be varied. With capacitance C, electrode surface area A, electric field constant ∈₁ and relative dielectric constant ∈₂ of the molding compound of the molding, the following relation is obtained for the capacitance density of the capacitor (capacitance per unit area):

$$\frac{C}{A} = \frac{{ɛ}_{0}}{\frac{{d}_{1}}{{ɛ}_{1}} + {d}_{2}} \qquad ( 1 )$$

The capacitor has at least two layers between the electrodes: a first layer (molding) with a high dielectric material and a second layer with a low dielectric material. While the layer thickness of the first layer with the high dielectric material is fixed, i.e. remains unchanged, the layer thickness of the second layer with the load dielectric material is varied. Instead of air, another low dielectric material can be provided for the second layer. The other low dielectric material is e.g. a gas other than air. A vacuum is likewise conceivable.

In a particular embodiment, the dielectric molding material has at least one composite material comprising at least one base material and at least one filler, the base material being a plastic, the filler having a relative dielectric constant of at least 50 and a filling ratio of the filler in the base material being selected such that the effective dielectric constant is at least 20 and in particular at least 40. Composite material is to be understood as meaning a material such as that obtained by combining different materials. The composite material is preferably present as a particle composite. The particle composite consists of a matrix formed from the base material of the composite material. The matrix contains a certain proportion of filler (filling ratio). The base material, the filler and the filling ratio are selected such that a relatively high effective dielectric constant is obtained for the resulting dielectric molding material. The effective relative dielectric constant is the outwardly acting relative dielectric constant. It results from the dielectric constant of the base material, the filler and the proportions of the materials involved.

As a filler, any material is conceivable. In particular the filler is a ceramic material. The ceramic material is preferably a capacitor ceramic. For example, the capacitor ceramic is a perovskite (ABO₃) and in particular an alkaline earth perovskite, the A-sites of the perovskite being occupied by one or more alkaline earth metals. In particular the capacitor ceramic is a material of the barium strontium titanate system ((Ba,Sr)TiO₃). The A-sites of the perovskite are occupied by barium and/or strontium, barium and strontium possibly being present in different proportions relative to one another. The B-sites of the perovskite are occupied by titanium.

To enable the surface roughness of the electrode surface to be smoothed out, the filler is contained in the composite material as a powder. The powder consists of powder particles with very small particle diameters. The surface roughness of the electrode surfaces is characterized by dimensions in the μm range. The filler therefore comprises a powder made of powder particles having an average diameter d₅₀ of less than 100 nm and in particular less than 50 nm. The average particle diameter in the nm range enables the surface roughness of the electrode surface to be smoothed out in the μm range.

The base material of the molding compound can be any plastic material. Using a ceramic material as a filler results in a polymer/ceramic molding compound. For example, the plastic material is an epoxy resin. The molding compound is a ceramic filled epoxy resin. The plastic material is preferably a non-cross-linked or only partially cross-linked plastic. By cross-linking, e.g. polymerization or condensation, the molding compound is transformed into the molding. It is also conceivable that the base material is a thermoplastic. The material is plastically deformable at elevated temperatures. A molding compound containing thermoplastic as base material is applied to the electrode surface at comparatively high temperatures, thereby taking an impression of the surface roughness of the electrode surface. The subsequent temperature reduction causes the molding compound to be transformed into the molding, the surface roughness of the electrode surface being reproduced in a complementary manner in the molding.

The molding and electrode surface can be detachably interconnected. Preferably, however, the electrode surface and molding are non-detachably interconnected. There exists a firm and intimate contact between the molding and the electrode surface, resulting in a reliable component. Adhesion between molding and electrode surface can be produced using a bonding agent (adhesive). The bonding agent ensures anchorage of the molding and electrode surface. For example, to produce the capacitor the adhesive is disposed as a thin film between the molding compound and the electrode surface. Curing or drying of the adhesive produces the lasting contact between the electrode surface and the molding compound or rather the molding produced from the molding compound, it being important that the adhesive is selected and applied so as to ensure that an impression of the electrode surface is taken by the molding compound.

However, application of an adhesive in the form of a thin film is not absolutely necessary, as in the case of epoxy resin as base material of the composite material of the molding compound. Here adhesion is provided by the base material of the molding compound itself. The base material of the molding compound acts as an adhesive. When the molding compound is transformed into the molding, the permanent bond between the molding and the electrode surface is produced. The transformation includes, for example, curing of the molding compound or rather of the base material of the molding compound. In addition to epoxy resin, any other adhesives are also conceivable. The adhesives can consist of one component or a plurality of components.

To produce the capacitor, the electrode surface can be provided with the molding compound and brought together with a substrate before or after transformation into the molding. In a preferred embodiment, to provide the electrode a substrate with the electrode is used. The electrode is disposed on a substrate.

Any single-layer or multilayer electrode support can be used as a substrate. The substrate is e.g. a semiconductor substrate on whose surface the electrode is produced using known technologies. A ceramic substrate is also conceivable. The electrode can be produced on a surface of the ceramic substrate using thin film technology (e.g. vapor deposition) or thick film technology (e.g. screen printing). In order to obtain a reliable component, it is advantageous if the dielectric molding compound or rather the dielectric molding adheres very well not only to one of the electrode surfaces but also to a substrate surface surrounding the electrode.

In addition to a homogeneous, internally featureless substrate, a multilayer substrate in particular is conceivable. A large number of passive electrical components can be incorporated in the volume of the multilayer substrate, thereby enabling electrical circuits to be implemented in a space-saving manner. The multilayer substrate can be a multilayer organic (MLO) or a multilayer ceramic (MLCC) substrate. As a ceramic substrate, a low temperature cofired ceramic (LTCC) comes particularly into consideration which, because of its low densification temperature, enables low melting point and highly electrically conductive metals such as silver and copper to be used for incorporating the passive components.

In a particular embodiment, at least one of the electrodes is connected to at least one piezoelectric actuator in such a way that the distance between the electrode and the counter-electrode can be varied by electrically energizing the actuator. Such a solution has the particular advantage that the distance between the electrodes and therefore the capacitance of the capacitor are steplessly adjustable. Due to the fact that the electrode surface is smoothed, the capacitance can also be very precisely adjusted.

The electrode which is connected to the actuator can be disposed electrically insulated from the piezo element of the actuator. The power losses due to the limited conductivity of the electrode metals can be minimized by design as well as the selection of material and manufacturing technology for the capacitor electrode and counter-electrode, thereby achieving high capacitor quality irrespective of the tuning range.

In a particular embodiment, the electrode which is connected to the actuator is an actuator electrode of the electrode. The actuator electrode is an electrode layer of a piezo element of the actuator.

The actuator can be embodied in any manner. The critical factor is that the piezoelectric deflection of the actuator is large enough to ensure that the desired change in the distance between the capacitor electrodes can be achieved. In order to achieve a relatively large deflection, an actuator can be used which has a large number of piezo elements vertically stacked to produce an actuator body, said piezo elements possibly being bonded together. This is a possible solution, for example, for piezo elements with piezoelectric layers made of a piezoelectric polymer such as polyvinylidene difluoride (PVDF). Piezoelectric layers made from a piezoceramic material are likewise conceivable. The piezoceramic material is, for example, a lead zirconate titanate (PZT) or a zinc oxide (ZnO). The piezo elements with piezoelectric layers made of piezoceramic material are, for example, not bonded together but combined in a common sintering process (co-firing) to form an actuator body of monolithic multilayer construction.

In a particular embodiment, the actuator is a piezoelectric flexural transducer. With said flexural transducer a relatively large piezoelectric deflection can be achieved by a relatively low drive voltage. Thus, for example, a drive voltage of less than 10 V is sufficient to produce a deflection of the flexural transducer of more than 10 μm. The large deflection achievable enables the distance between capacitor electrode and counter-electrode to be varied over a wide range, thereby enabling the capacitance of the capacitor to be varied over a wide range.

The flexural transducer can be embodied as a so-called bimorph. In a flexural transducer of this kind, a piezoelectrically active layer (piezoelectric layer of the piezo element) non-detachably combined with a piezoelectrically inactive layer. Applying drive to the electrode layers of the piezo element of the flexural transducer causes the piezoelectrically active layer to be piezoelectrically deflected. The piezoelectrically inactive layer, on the other hand, is not deflected by the drive applied to the electrode layers of the piezo element. The rigid bonding between the layers causes the flexural transducer to bend. The piezoelectrically inactive layer can typically be a thin silicon membrane which has been sputtered onto the piezoelectrically active layer.

Alternatively, a multimorph having a plurality of piezoelectrically active layers rigidly connected to one another is also conceivable. The piezoelectrically active layers can be combined to form a single piezo element. The piezoelectrically active layers together form the piezoelectric layer of the piezo element. It is also conceivable for a plurality of piezo elements each with a piezoelectric active layer to be arranged into a multilayer composite. By energizing the electrode layers of the piezo element or of the piezo elements of the flexural transducer, there are produced, for example, in the piezoelectrically active layers, different electrical fields which results in different deflections of the piezoelectrically active layers. The different deflections of the piezoelectrically active layers cause the flexural transducer to bend.

In a particular embodiment, an anti-adhesion layer is disposed on the molding compound and/or on the counter-electrode between the counter-electrode and the dielectric molding compound. If the molding is to be adhesively disposed on the electrode surface of the counter-electrode, the anti-adhesion layer is disposed between the electrode and the dielectric molding compound and/or on the electrode. A permanent and intimate contact is established between the molding and only one of the electrodes. The molding compound or the molding and the other electrode are detachably connected to one another. The anti-adhesion layer is preferably embodied in such a way that it is possible for the dielectric molding compound to take an impression of the electrode surface of one of the electrodes. For this purpose, according to a particular embodiment an anti-adhesion layer with a plastically deformable plastic layer is used. Such a layer is formed, for example, by surface treatment of the molding compound. The surface treatment can be drying, irradiating with electromagnetic radiation or a reaction with a reactive gas or a reactive liquid. A film is formed on the molding compound which prevents adhesion between the corresponding electrode surface and the molding compound. In another embodiment, an oil film is used as the anti-adhesion layer. The oil film is applied to the not yet cured molding compound or to the counter-electrode. The counter-electrode and the molding compound are then brought together. An impression of the surface of the counter-electrode is taken by the dielectric molding compound. Subsequent transformation of the dielectric molding compound into the dielectric molding causes the surfaces of both electrodes to be smoothed out. A permanent contact is only produced with one of the electrodes, so that the distance between the electrodes can be varied via a variable air gap. When the dielectric molding compound has cured, the oil film is removed using a suitable solvent.

To produce the capacitor, a prefabricated capacitor with a variable distance between the electrode and the counter-electrode can be prepared for which at least one of the electrode surfaces is subsequently provided with the molding compound. The procedure is typically as follows: providing a variable capacitance capacitor having at least one electrode and at least one counter-electrode disposed opposite the electrode as a variable distance from said electrode, at least one of the electrodes being connected to at least one piezoelectric actuator in such a way that by electrically energizing the actuator the distance between the electrode and the counter-electrode can be varied, bringing together a dielectric molding compound and an electrode surface of at least one of the electrodes of the capacitor so that an impression is taken of the electrode surface by the dielectric molding compound, and transforming the dielectric molding compound into the molding, a non-detachable connection existing between the molding and the dielectric surface.

In a preferred embodiment, the capacitor and the molding are produced more or less simultaneously. For this purpose the following additional steps are carried out: d) providing a substrate containing the electrode and an electrical connection to the electrical contacting of the counter-electrode of the capacitor, e) applying an electrically conductive molding compound to the electrical connection, f) connecting the counter-electrode and the electrically conductive molding compound and g) transforming the electrically conductive molding compound into an electrically conductive molding. A conductive adhesive is preferably used as the electrically conductive molding compound. The conductive adhesive is a composite material in which, in contrast to the dielectric molding compound, electrically conductive particles are used as a filler. The transforming of the dielectric molding compound into the dielectric molding and the transforming of the electrically conductive molding compound into the electrically conductive molding can take place simultaneously or consecutively.

For example, the dielectric molding compound is applied to the prepared electrode and the electrically conductive molding compound is applied to the electrical connection. The dielectric molding compound is dried so that a non-adhesive but plastically deformable skin (anti-adhesion layer) is produced on the molding compound. The counter-electrode is then brought together with the dielectric molding compound and the electrically conductive molding compound. The dielectric molding compound and the electrically conductive molding compound are cured. Curing of the electrically conductive molding compound causes the counter-electrode to be non-detachably connected to the resulting electrically conductive molding and therefore to the electrical connection. This results in a permanent electrical contact via which the counter-electrode can be supplied with voltage. In contrast, no lasting contact is produced between the counter-electrode and the dielectric molding compound. An impression is only taken of the surface roughness of the counter-electrode. Curing of the dielectric molding compound produces the dielectric molding which exhibits both the surface roughness of the electrode and the surface roughness of the counter-electrode. However, the dielectric molding is non-detachably connected only to the electrode.

The variable capacitance capacitor is preferably used for adjusting a frequency band of a frequency filter. Through the possibility of varying a frequency band of a frequency filter over a wide range by electrically energizing a tunable capacitor, the invention can be used to realize a communications or cellular radio concept known as “software defined radio” (SDR). The object of SDR is to implement not discrete frequency bands but continuously variable frequency bands for communications or mobile radio. With the tunable capacitor of the present invention, a basic building block for implementing SDR is provided.

To summarize, the invention provides the following essential advantages:
with the aid of the dielectric molding, the surface roughness of at least one of the capacitor's electrodes is reduced. This means that a very small air gap is accessible between the capacitor's electrodes.
the capacitor's capacitance can be varied over wide range because of the small air gap and by using a molding containing a high dielectric molding material.
the capacitor's capacitance can be very precisely adjusted over a wide range by adjusting the distance using the piezoelectric actuator.
the capacitor is very easy to manufacture.

The invention will now be described in greater detail with reference to several exemplary embodiments and the associated drawings. The figures are schematic and not to scale.

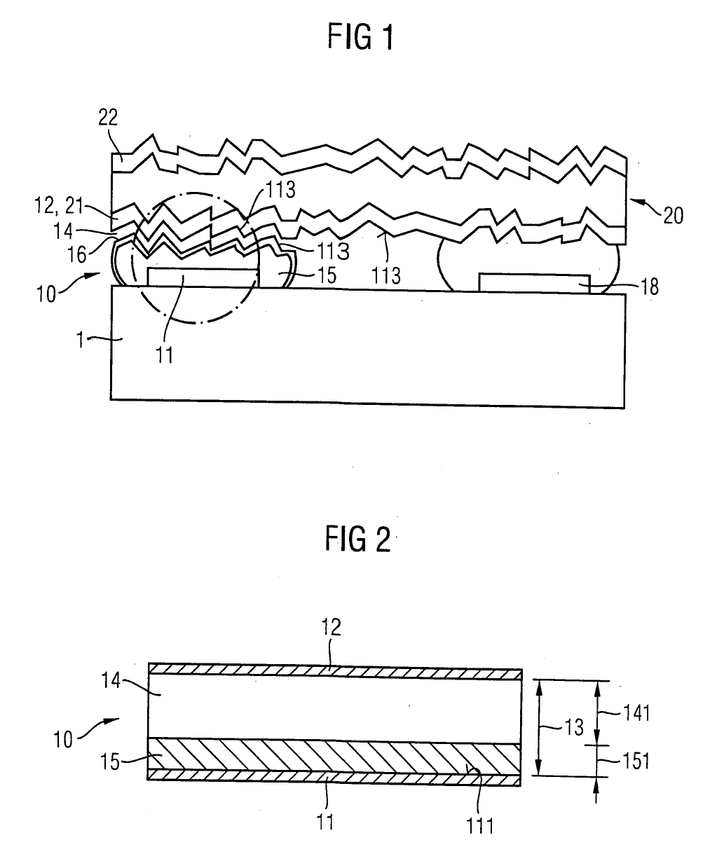

FIG. 1 shows a capacitor with tunable capacitance in lateral cross-section.

FIG. 2 shows the operating principle of a capacitor with tunable capacitance by varying the distance between the capacitor's electrode and counter-electrode.

The main interrelationships on which the invention is based are shown in FIG. 2. The capacitor 10 has an electrode 11 and a counter-electrode 12 disposed at a distance 13 from the electrode 11 and opposite said electrode 11. The distance 13 between the electrode 11 and the counter-electrode 12 is variable. This means that the electrode 11 and the counter-electrode 12 can be moved together and apart from one another.

To the electrode surface 111 of the electrode 11 there is applied, within the distance 13, a dielectric molding 15 in the form of a dielectric layer with a layer thickness 151. The material of the dielectric layer 15 has an effective relative dielectric constant of approximately 40. The layer thickness 151 of the dielectric layer 15 is constant, i.e. invariable. Between the dielectric layer 15 and the counter-electrode 12 of the capacitor 10 there is an air gap 14 with a variable gap width 141. By varying the gap width 141 of the air gap 14, the distance 13 between the electrode 11 and the counter-electrode 12 of the capacitor 10 is varied. The smaller the distance 13 between the electrodes 11 and 12 can be selected, the wider the tuning range of the capacitor.

It is particularly advantageous to use a piezoelectric flexural transducer 20 to adjust the distance 13 between the electrodes 11 and 13. The flexural transducer 20 is a ceramic flexural transducer, for example. The ceramic flexural transducer 20 is characterized by rough surfaces. FIG. 1 shows, in greatly exaggerated form, a piezoelectric flexural transducer 20 with rough surfaces 22 which is coated with actuator electrodes 21 and 22. The coating is performed by vapor deposition with metal. The surface roughness of the flexural transducer 20 is therefore replicated in the surface roughness of the actuator electrodes 21 and 22. In particular the surface roughness of the actuator electrode 21 which is used as the counter-electrode 12 of the capacitor 10 makes it difficult to adjust a narrow air gap 14 precisely. The surface roughness of at least one of the electrodes 11 or 12 is therefore smoothed out using the dielectric molding (dielectric layer) 15. The dielectric molding consists of a composite material. The base material of the composite material is an epoxy resin. The epoxy resin is filled with a powder of the barium strontium titanate system. An average particle diameter of the powder is less than 100 nm.

To produce the capacitor 10 the procedure is as follows: first a substrate 1 with the electrode 11 of the capacitor 10 is provided. The substrate is a ceramic multilayer substrate. The prepared substrate 1 has an electrical connection 18 for electrical contacting the counter-electrode 12 of the capacitor 10. A dielectric molding compound 150 is applied to the electrode 11 of the capacitor 10 and an electrically conductive molding compound 170 is applied to the electrical connection 18. The dielectric molding compound 150 undergoes surface treatment to produce an anti-adhesion coating 16. The anti-adhesion coating 16 is plastically deformable. Then the counter-electrode 12 is brought together with the dielectric molding compound 150 and the electrically conductive molding compound 170. The bringing-together takes place under pressure, thereby imparting to the dielectric molding compound 150 and the electric molding compound 170 the microscopic roughness of the actuator underside formed by the actuator electrode 21 of the flexural transducer 20. By means of suitable material properties, it is ensured that adhesion with the actuator underside only takes place in the case of the electrically conductive molding compound 170. Because of the anti-adhesion layer 16, adhesion of the actuator underside of the flexural transducer 20 to the dielectric molding compound 150 does not take place.

The molding compounds 150 and 170 are then cured. The dielectric molding 15 and the electrically conductive molding 17 are formed, thereby producing a lasting bond between the electrical connection 18, the electrically conductive molding 17 and the counter-electrode 12 of the capacitor (actuator electrode 21 of the flexural transducer 20). There is likewise produced a permanent bond between the dielectric molding 15 and the electrode 11 of the capacitor 10. A detachable connection is formed between the dielectric molding 15 and the counter-electrode 12. Because of the detachable connection, the gap width 141 of the air gap 14 can be adjusted using the piezoelectric flexural transducer. As surface roughness 113 of the electrodes 11 and 12 are smoothed out, the gap width of the air gap 14 can be very precisely adjusted.

The tunable capacitor 10 described is used for adjusting the frequency band of a frequency filter.

1. A variable capacitance capacitor (10), comprising
at least one electrode (11, 12) and
at least one counter-electrode (12, 11) disposed opposite the electrode (11, 12) at a variable distance (13) from said electrode (11, 12),
characterized in that
within the distance (13) between the electrode (11, 12) and the counter-electrode (12, 11) there is disposed on an electrode surface (111, 121) of at least one of the electrodes (11, 12) at least one dielectric molding (14) with a dielectric molding material for smoothing out any surface roughness (113) of the electrode surface (111, 121).

2. The capacitor as claimed in claim 1, wherein the dielectric molding material has an effective relative dielectric constant of at least 20 and in particular of at least 40.

3. Capacitor has claimed in claim 2, wherein
the dielectric molding material comprises at least one composite material with at least one base material and at least one filler,
the base material is a plastic,
the filler has a relative dielectric constant of at least 50 and
a filling ratio of the filler in the base material is selected such that the effective dielectric constant is at least 20 and in particular at least 40.

4. The capacitor as claimed in claim 3, wherein the filler has a powder made of powder particles with an average particle diameter d₅₀ of less than 100 nm and in particular of less than 50 nm.

5. The capacitor as claimed in claim 3, wherein the plastic material is an adhesive.

6. The capacitor as claimed in claim 1, wherein at least one of the electrodes (11, 12) is connected to at least one piezoelectric actuator (20) in such a way that by electrically energizing the actuator (20) the distance (13) between the electrode (11, 12) and the counter-electrode (12, 11) can be varied.

7. The capacitor as claimed in claim 6, wherein the electrode which is connected to the actuator (20) is an actuator electrode (21) of the actuator (20).

8. The capacitor as claimed in claim 6, wherein the actuator (20) is a piezoelectric flexural transducer.

9. A method for producing the capacitor (10) as claimed in claim 1, comprising the following steps:
a) providing the capacitor electrode,
b) applying a dielectric molding compound to the electrode surface so that an impression of the electrode surface is taken by the molding compound and
c) transforming the dielectric molding compound into the dielectric molding containing the dielectric molding material, the surface roughness of the electrode surface being smoothed out.

10. The method as claimed in claim 9, wherein on transformation of the molding compound into the molding a non-detachable connection between the molding and the electrode surface is produced.

11. The method as claimed in claim 9, wherein to provide the electrode a substrate (1) containing the electrode is used.

12. The method as claimed in claim 9, comprising the following subsequent steps:
d) providing a substrate containing the electrode and an electrical connection for electrically contacting the counter-electrode of the capacitor,
e) applying an electrically conductive molding compound to the electrical connection,
f) connecting the counter-electrode and electrically conductive molding compound and
g) transforming the electrically conductive molding compound into an electrically conductive molding.

13. The method as claimed in claim 12, wherein a conductive adhesive is used as the electrically conductive molding compound.

14. The method as claimed in claim 12, wherein there is disposed between the counter-electrode and the dielectric molding compound an anti-adhesion layer on the molding compound and/or on the counter-connector.

15. The method as claimed in claim 14, wherein an anti-adhesion layer with a plastically deformable plastic layer is used.

16. The method as claimed in claim 14, wherein an anti-adhesion layer with an oil film is used.

17-18. (canceled)

19. The capacitor as claimed in claim 7, wherein the actuator (20) is a piezoelectric flexural transducer.

20. The method as claimed in claim 10, wherein to provide the electrode a substrate (1) containing the electrode is used.

21. The method as claimed in claim 13, wherein there is disposed between the counter-electrode and the dielectric molding compound an anti-adhesion layer on the molding compound and/or on the counter-connector.

22. The method as claimed in claim 15, wherein an anti-adhesion layer with an oil film is used.
